(19) United States
(12) Patent Application Publication
(10) Pub. No.: US 2024/0256395 A1
(43) Pub. Date: Aug. 1, 2024

(54) Method and System for Instant Availability of Container Platform Workloads

(71) Applicant: Dell Products L.P., Round Rock, TX (US)

(72) Inventors: Salil Gupta, Bangalore (IN); Bahubali Jain, Kalaburgi (IN); Prakash Venkatanarayanan, Framingham, MA (US); Thomas L. Watson, Richardson, TX (US); Abhijit Tripathy, Bangalore (IN); Harish Prabhakara, Bangalore (IN)

(73) Assignee: Dell Products L.P., Round Rock, TX (US)

(21) Appl. No.: 18/104,049

(22) Filed: Jan. 31, 2023

(51) Int. Cl. G06F 11/14; G06F 11/20

(52) U.S. Cl. CPC G06F 11/1466; G06F 11/1464; G06F 11/2056; G06F 2201/84

(57) ABSTRACT

Described are system and methods that provide instant access of data of a workload/container-based application, allowing the workload/container-based application to be recreated at the destination container platform. A connection is established between the destination container platform and a source storage; A volume of the container-based application is taken and stored to the source storage. A storage accessed by the destination container platform creates a proxy volume which maps and copies data of the snapshot. The data is pulled from the proxy volume as needed to recreate the container-based application at the destination host platform.

### BACKGROUND OF THE INVENTION

### Field of the Invention

The present invention relates to workloads/container-based applications running on information handling systems. More specifically, embodiments of the invention provide for instant availability of workloads/container-based applications of container-based platforms.

### Description of the Related Art

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

An emerging technology is container orchestration ecosystems employing container platforms, such as Kubernetes. Container orchestration ecosystems provide containers, where a container is a standard package of software, bundling application code along with configuration files and libraries. The use of container-based applications allows the ability to deploy applications seamlessly across various environments (e.g., information handling systems). Container platforms include clusters, which include a set of nodes or “machines”. The nodes can include master and worker nodes that run containerized applications. A cluster (e.g., Kubernetes cluster) is a set of nodes that run container-based applications. A workload (e.g., Kubernetes workload) is a container-based application running on the container platform (e.g., Kubernetes platform). A container is a lightweight and portable image that contains software and dependencies. Pods are the smallest deployable units of computing that are created and managed in a platform (e.g., Kubernetes platform). A pod represents a set of containers that are run on a cluster. Workloads are run on a set of pods.

Production workload/container-based application of one cluster may be running on various locations, such as on premise (i.e., site), cloud (e.g., private/public, hybrid), etc. In certain cases, it is desirable to provide those production workloads/container-based applications to other instances of the same workload/container-based application on another cluster running on a different location without having to copy data. This can apply to testing, development, and analytics. For example, it may be a prolong wait (e.g., days) for data to be copied to get access to such production workloads. With the emerging increase in the use of workload/container-based applications, it becomes desirable to have “instant access” to such workloads.

### SUMMARY OF THE INVENTION

A computer-implementable method, system and computer-readable storage medium for instant access to data of a container-based application comprising establishing a connection between a destination host platform and a source storage; taking a snapshot of the volume of the container-based application and storing the snapshot on the source storage; initiating a microservice on a storage accessed by the destination host platform; creating a proxy volume on the storage accessed by the destination host platform; mapping and copying data of the snapshot of the volume of the container-based application to the proxy volume; and pulling data from the proxy volume as needed to recreate the container-based application at the destination host platform.

### BRIEF DESCRIPTION OF THE DRAWINGS

The present invention may be better understood, and its numerous objects, features and advantages made apparent to those skilled in the art by referencing the accompanying drawings. The use of the same reference number throughout the several figures designates a like or similar element.

FIG. 1 is a general illustration of components of an information handling system as implemented in the present invention;

FIG. 2 illustrates a system as implemented in the present invention;

FIG. 3 is a generalized flowchart for instant availability of workloads/container-based applications of container-based platforms; and

FIG. 4 is a generalized flowchart for instant access to data of a container-based application.

### DETAILED DESCRIPTION

Described herein are implementations that migrate workloads/container-based applications from a source cluster to a destination cluster, while providing instant availability of data of the migrated workload/container-based application on the destination cluster.

Implementations provide for the use of an application mobility controller or mobility application to backup and migrate cluster resources of the workload/container-based application from the source cluster to the destination cluster, providing instant accessibility from a storage array of the destination platform of the destination cluster to read data from a source storage, without having to copy the entire data of the source cluster.

The mobility application performs as an orchestrator that can use existing controllers and calls through container storage interface (CSI) drivers to the source storage and storage arrays, using APIs (e.g., REST API).

Data copy can take place in the background, or background copy, using a copy engine of the storage array of the destination platform, without host (i.e., destination platform) resources or solutions. In particular, an array (i.e., storage) to array data mover can be implemented.

Implementations provide for a “pull” mode where instant access is provided, even though background copy is in progress. Any missing data is pulled from the source storage based on need. Instant access provides a way to access remote source data from the source storage without waiting for the entry copy operation to complete.

For purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, gaming, or other purposes. For example, an information handling system may be a personal computer, a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a microphone, keyboard, a video display, a mouse, etc. The information handling system may also include one or more buses operable to transmit communications between the various hardware components.

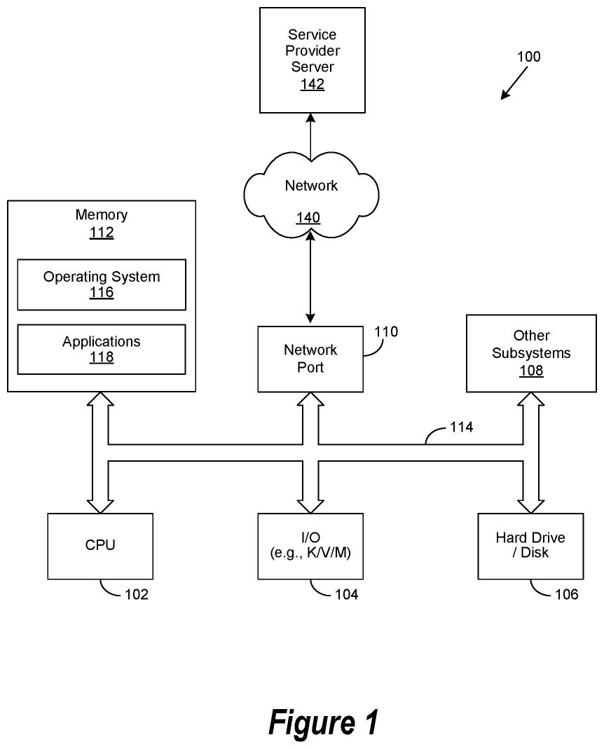

FIG. 1 is a generalized illustration of an information handling system (IHS) 100 that can be used to implement the system and method of the present invention. The information handing system (IHS) 100 can be a host to the peripheral devices described herein.

The information handling system (IHS) 100 includes a processor (e.g., central processor unit or “CPU”) 102, input/output (I/O) devices 104, such as a microphone, a keyboard, a video display or display device, a mouse, and associated controllers (e.g., K/V/M), a hard drive or disk storage 106, and various other subsystems 108.

In various embodiments, the information handling system (IHS) 100 also includes network port 110 operable to connect to a network 140, where network 140 can include one or more wired and wireless networks, including the Internet. Network 140 is likewise accessible by a service provider server 142.

The information handling system (IHS) 100 likewise includes system memory 112, which is interconnected to the foregoing via one or more buses 114. System memory 112 can be implemented as hardware, firmware, software, or a combination of such. System memory 112 further includes an operating system (OS) 116, and one or more application(s) 118.

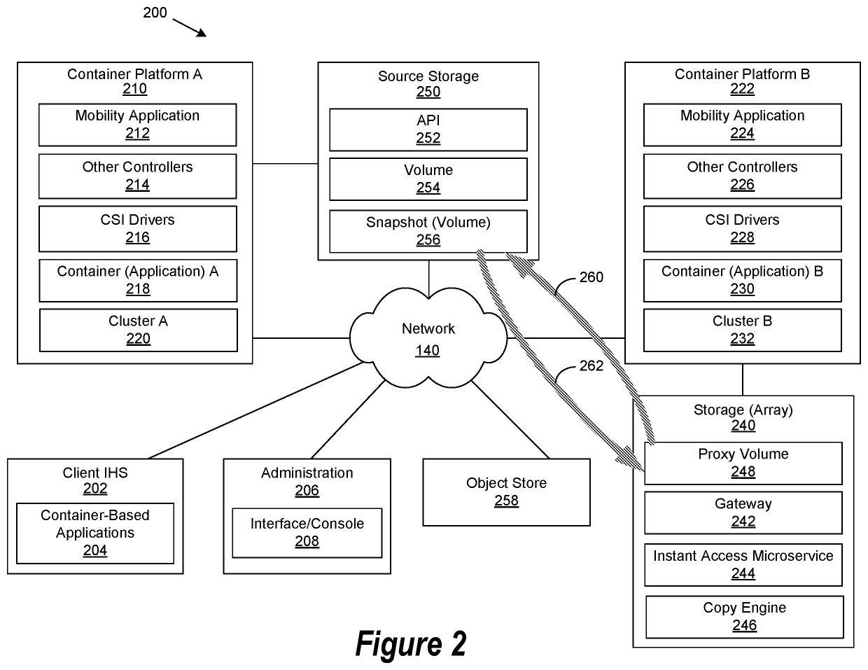

FIG. 2 illustrates a system 200 for instant availability of workloads/container-based applications of container-based platforms. The system 200 represents a container orchestration ecosystem, such as systems based using Kubernetes. One or more client information handling systems, represented as client IHS 202 are included in the system 200. The client IHS 202 can be embodied as an IHS 100 as described in FIG. 1.

Implementations provide for client IHS 202 to include container-based applications 204, which can be container images or containers. A container image is a lightweight, standalone, executable package of software that includes what is used to run an application (i.e., include container-based applications 204), such as code, runtime, system tools, system libraries, and settings. Container images are used to instantiate containers at application runtime. The container image(s) or container(s) are designed to be standardized to be portable and secure, and lightweight to allow the ability to use or share an operating system of the client IHS 202. Client IHS 202 is connected to network 140, where network 140 as described in FIG. 1, includes one or more wired and wireless networks, including the Internet. Network 140 connects IHS 202 with other elements of system 200 as described herein.

The system 200 further can include an administration element 206 which includes an interface/console 208 to access/communicate with client IHS 202. The administration element 206 is accessible by a user, such as an administrator or IT personnel.

Implementations provide for the system 200 to include a host or container platform A 210, which is considered a source host or source container platform. The container platform A 210 can be embodied as one or more information handling systems (IHS), as cloud computing, etc., and can be located at various locations, such as on premise (i.e., site), cloud (e.g., private/public, hybrid), etc. The container platform A 210 is connected to other elements of the system 200 by network 140.

Implementations provide for the container platform A 210 to include an application mobility controller or mobility application 212, other controllers 214, CSI drivers 216, workload/container-based application or container A 218 and a cluster A 220. Container A 218 is considered as a source container. Cluster A 220 is considered as a source cluster.

Implementations provide for the system 200 to include a host or container platform B 222, which is considered a destination host or destination container platform. The container platform B 222 can be embodied as one or more information handling systems (IHS), as cloud computing, etc., and can be located at various locations, such as on premise (i.e., site), cloud (e.g., private/public, hybrid), etc. The container B 222 is connected to other elements of the system 200 by network 140.

Implementations provide for the container platform B 222 to include an application mobility controller or mobility application 224, other controllers 226, CSI drivers 228, workload/container-based application or container B 230 and a cluster B 232. Container B 230 is considered as a destination container. Cluster B 232 is considered as a destination cluster.

Implementations provide for the container platform B 222 to include or be connected to a storage array or storage 240. The storage 240 can include a gateway (e.g., REST gateway) 242, an instant access microservice 244, a copy engine 246, and a proxy volume 248.

The system 200 can include a source storage 250 that is directly connected or included with the container platform A 210. Source storage is also accessible by the container platform B 222. Access can be through network 140 or a direct connection. Implementations provide for the source storage 250 to include an API (e.g., REST API) 252, a volume 254, and a snapshot volume or snapshot 256.

Implementations further provide for the system 200 to include an object store 258, such as an RESTIC object storage. In certain implementations, container platform A 210 exports meta data to the object store 258, and the container B 230 imports meta data from the object store 258.

As further discussed herein, in supporting instant access a read request 260 is sent from the proxy volume 248 to request data from the proxy volume from the source storage (e.g., via container platform B 222). A pull 262 is performed that provides missing data from the source storage 250 (i.e., snapshot 256).

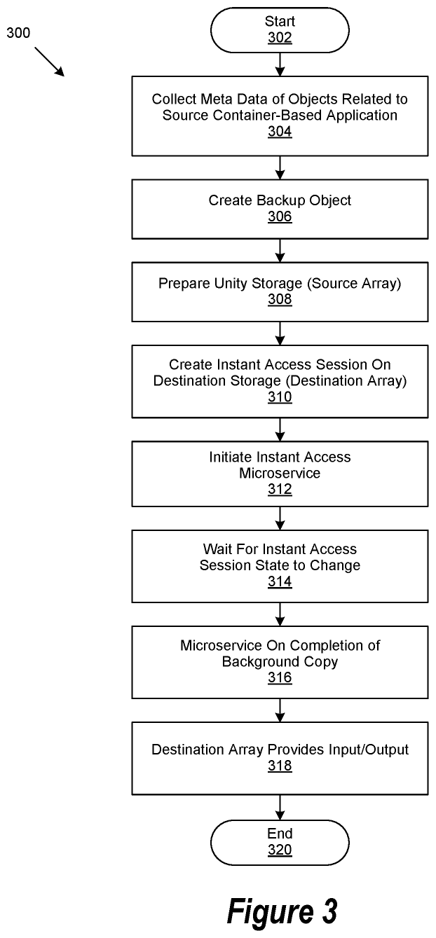

FIG. 3 shows a process 300 for instant availability of workloads/container-based applications of container-based platforms. The order in which the method is described is not intended to be construed as a limitation, and any number of the described method steps may be combined in any order to implement the method, or alternate method. Additionally, individual steps may be deleted from the method without departing from the spirit and scope of the subject matter described herein. Furthermore, the method may be implemented in any suitable hardware, software, firmware, or a combination thereof, without departing from the scope of the invention. For example, implementations provide for the described system 200 of FIG. 2, to perform the process 300 and the steps described herein.

At step 302, the process 300 starts. At step 304, meta data of objects related to the source workload/container-based application or container A 218 is collected. The mobility application 212 can be implemented for the collection. The objects can include pod, persistent volume claim, persistent volumes, namespaces, etc. The collected objects can be stored to the object store 258.

At step 306, backup object is created. The mobility application 212 can be implemented for the creation. The backup object can be stored to the object store 258.

At step 308, the source array or source storage 250 is prepared. Implementations provide for the use of API 252 to take a snapshot (i.e., snapshot 256) of the volume (i.e., volume 254) of the workload of the source workload/container-based application or container A 218. The API 252 can return an ID of the snapshot 256 of the volume 254 to cluster A 220.

At step 310, an instant access session is created on the destination storage or array (i.e., storage 240). The instant access session can be created by the mobility application 224 of the container platform B 222 through an API or gateway 242. In this step the source storage 250 is added as remote system to the storage 240, allowing storage 240 to communicate with source storage 250. Management and data path connectivity (e.g., isCSI) is established between source storage 250 and storage 240. An ID of the source storage 250 can be returned to the storage 240. In addition, the destination host or container platform B 222 can be configured as an external source to the storage 240 providing access to remote snapshot data when made available. The container platform B 222 can return an ID. Furthermore, creation of an instant access type remote session between source storage 250 and storage 240 can be created with the following parameters: remote system (i.e., source storage 250) ID, host (i.e., container platforms 210 and 222) IDs, source snapshot (i.e., snapshot 256) ID. A session ID can be returned with an INITIALIZE condition.

At step 312, instant access microservice is initiated. In particular, the instant access microservice 244 of the storage 240 is initiated and can be performed asynchronously. In this step, the proxy volume 248 is created. Using an adaptor on the storage 240 a remote snapshot can be mapped to and discovered on storage 240. In addition, a mirror is enabled on the proxy volume. The mirror is between the proxy volume 248 on storage 240 and the snapshot 256 on the source storage 250. Read operation is directed to the source storage 250 (i.e., a read request 260) if data is not available on proxy volume 248, and write is performed to the proxy volume 248 (i.e., pull 262). Implementations further provide for attaching the proxy volume 248 to a host/host group (i.e., container platform B 222) ID that can be passed as part of a command. Instant access session condition can be changed from INITIATE to IO_FORWARDING. A background copy can be started, which copies data from source snapshot 256 to destination proxy volume 248. Implementations can provide for updating the session with a progress percentage.

At step 314, the mobility application 224 waits for the instant access session condition to be changed from INITIATE to IO_FORWARDING. Once the session state changed to IO_FORWARDING, the mobility application 224 restores backup objects (e.g., pod, persistent volume claim, persistent volumes, namespaces, etc.) that were created on the source cluster A 220 to the destination cluster B 232. This results in the workload/container-based application being available on the destination cluster B 232. Furthermore, volume (i.e., snapshot 256) referenced is mapped by the application to the proxy volume 248. The workload/container-based application is started on the destination cluster B 232.

At step 316, upon completion of background copy, the instant access microservice 244 performs the following. Instant access session condition is changed to COMPLETED. Background copy is stopped. The mirror is disabled. Mapping is removed between storage 240 and snapshot 256 of source storage 250. The proxy volume 248 becomes a regular local volume on the storage 240.

At step 318, all input and outputs are provided by the destination storage 240. At step 320, the process 300 ends.

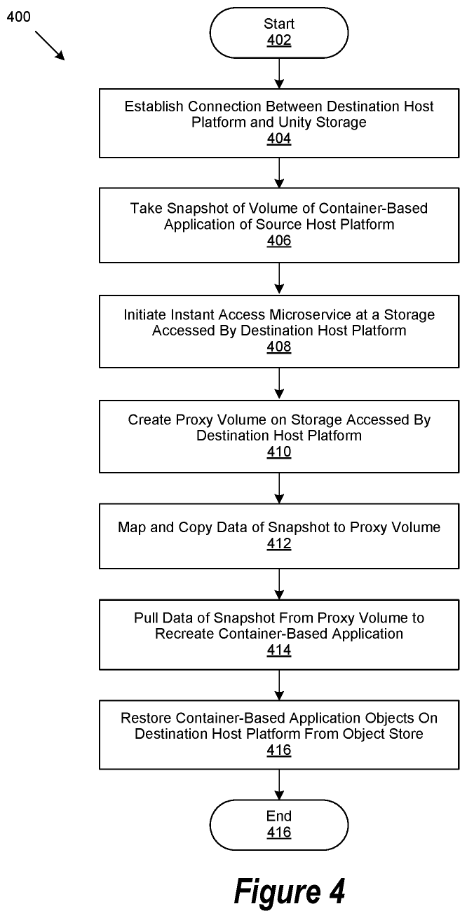

FIG. 4 shows a process 400 for instant access to data of a container-based application. The order in which the method is described is not intended to be construed as a limitation, and any number of the described method steps may be combined in any order to implement the method, or alternate method. Additionally, individual steps may be deleted from the method without departing from the spirit and scope of the subject matter described herein. Furthermore, the method may be implemented in any suitable hardware, software, firmware, or a combination thereof, without departing from the scope of the invention. For example, implementations provide for the described system 200 of FIG. 2, to perform the process 400 and the steps described herein.

At step 402, the process 400 starts. At step 404, a connection is established between destination host platform (e.g., container platform B 222) and source storage (e.g., source storage 250). The source host platform and destination host platform are able to directly communicate and receive/provide data from the source storage.

At step 406, a snapshot of a volume of the container-based application of the source host platform is taken. The snapshot is stored to the source storage.

At step 408, a microservice is initiated at the storage accessed by the destination host platform.

At step 410, a proxy volume is created at the storage accessed by the destination host platform.

At step 412, data of the snapshot taken of the volume stored in the source storage is mapped and copied to the proxy volume.

At step 414, data is pulled as needed from the proxy volume to recreate the container-based application at the destination host platform.

At step 416, the container-based application objects are restored on the destination host platform from object store. At step 418, the process 400 ends.

The present invention is well adapted to attain the advantages mentioned as well as others inherent therein. While the present invention has been depicted, described, and is defined by reference to particular embodiments of the invention, such references do not imply a limitation on the invention, and no such limitation is to be inferred. The invention is capable of considerable modification, alteration, and equivalents in form and function, as will occur to those ordinarily skilled in the pertinent arts. The depicted and described embodiments are examples only and are not exhaustive of the scope of the invention.

As will be appreciated by one skilled in the art, the present invention may be embodied as a method, system, or computer program product. Accordingly, embodiments of the invention may be implemented entirely in hardware, entirely in software (including firmware, resident software, micro-code, etc.) or in an embodiment combining software and hardware. These various embodiments may all generally be referred to herein as a “circuit,” “module,” or “system.” Furthermore, the present invention may take the form of a computer program product on a computer-usable storage medium having computer-usable program code embodied in the medium.

Any suitable computer usable or computer readable medium may be utilized. The computer-usable or computer-readable medium may be, for example, but not limited to, an electronic, magnetic, optical, electromagnetic, infrared, or semiconductor system, apparatus, or device. More specific examples (a non-exhaustive list) of the computer-readable medium would include the following: a portable computer diskette, a hard disk, a random-access memory (RAM), a read-only memory (ROM), an erasable programmable read-only memory (EPROM or Flash memory), a portable compact disc read-only memory (CD-ROM), an optical storage device, or a magnetic storage device. In the context of this document, a computer-usable or computer-readable medium may be any medium that can contain, store, communicate, or transport the program for use by or in connection with the instruction execution system, apparatus, or device.

Computer program code for carrying out operations of the present invention may be written in an object-oriented programming language such as Java, Smalltalk, C++ or the like. However, the computer program code for carrying out operations of the present invention may also be written in conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a local area network (LAN) or a wide area network (WAN), or the connection may be made to an external computer (for example, through the Internet using an Internet Service Provider).

Embodiments of the invention are described with reference to flowchart illustrations and/or step diagrams of methods, apparatus (systems) and computer program products according to embodiments of the invention. It will be understood that each step of the flowchart illustrations and/or step diagrams, and combinations of steps in the flowchart illustrations and/or block diagrams, can be implemented by computer program instructions. These computer program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram step or steps.

These computer program instructions may also be stored in a computer-readable memory that can direct a computer or other programmable data processing apparatus to function in a particular manner, such that the instructions stored in the computer-readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

The present invention is well adapted to attain the advantages mentioned as well as others inherent therein. While the present invention has been depicted, described, and is defined by reference to particular embodiments of the invention, such references do not imply a limitation on the invention, and no such limitation is to be inferred. The invention is capable of considerable modification, alteration, and equivalents in form and function, as will occur to those ordinarily skilled in the pertinent arts. The depicted and described embodiments are examples only and are not exhaustive of the scope of the invention.

Consequently, the invention is intended to be limited only by the spirit and scope of the appended claims, giving full cognizance to equivalents in all respects.

What is claimed is:

1. A computer-implementable method for instant access to data of a container-based application comprising:
establishing a destination host platform and a source storage;
taking a snapshot of the volume of the container-based application and storing the snapshot on the source storage;
initiating a microservice on a storage accessed by the destination host platform;
creating a proxy volume on the storage accessed by the destination host platform;
mapping and copying data of the snapshot of the volume of the container-based application to the proxy volume; and
pulling data from the proxy volume as needed to recreate the container-based application at the destination host platform.

2. The computer-implementable method of claim 1, wherein the establishing the connection includes establishing management and data path connectivity between the source storage and the storage accessed by the destination host platform.

3. The computer-implementable method of claim 1, wherein the source host platform and destination host platform are located at different locations or sites.

4. The computer-implementable method of claim 1, wherein the snapshot of the volume includes all objects to recreate a destination cluster of container-based application.

5. The computer-implementable method of claim 1, wherein the microservice creates a mirror on the proxy volume to the snapshot on the source storage to allow for read and write.

6. The computer-implementable method of claim 1, wherein the proxy volume requests and receives any needed data from the source storage.

7. The computer-implementable method of claim 1 further comprising performing backup of the container-based application while allowing for instant access.

8. A system comprising:
a plurality of processing systems communicably coupled through a network, wherein the processing systems include non-transitory, computer-readable storage medium embodying computer program code interacting with a plurality of computer operations for instant access to data of a container-based application comprising:
establishing a source host platform and a source storage;
taking a snapshot of the volume of the container-based application and storing the snapshot on the source storage;
initiating a microservice on a storage accessed by the destination host platform;
creating a proxy volume on the storage accessed by the destination host platform;
mapping and copying data of the snapshot of the volume of the container-based application to the proxy volume; and
pulling data from the proxy volume as needed to recreate the container-based application at the destination host platform.

9. The system of claim 8, wherein the wherein the establishing the connection includes establishing management and data path connectivity between the source storage and the storage accessed by the destination host platform.

10. The system of claim 8, wherein the wherein the source host platform and destination host platform are located at different locations or sites.

11. The system of claim 8, wherein the snapshot of the volume includes all objects to recreate a destination cluster of container-based application.

12. The system of claim 8, wherein the wherein the microservice creates a mirror on the proxy volume to the snapshot on the destination storage to allow for read and write.

13. The system of claim 8, wherein the proxy volume requests and receives any needed data from the source storage.

14. The system of claim 8 further comprising further comprising performing backup of the container-based application while allowing for instant access.

15. A non-transitory, computer-readable storage medium embodying computer program code for instant access to data of a container-based application, the computer program code comprising computer executable instructions configured for:
establishing a connection between a destination host platform and a source storage;
taking a snapshot of the volume of the container-based application and storing the snapshot on the source storage;
initiating a microservice on a storage accessed by the destination host platform;
creating a proxy volume on the storage accessed by the destination host platform;
mapping and copying data of the snapshot of the volume of the container-based application to the proxy volume; and
pulling data from the proxy volume as needed to recreate the container-based application at the destination host platform.

16. The non-transitory, computer-readable storage medium of claim 15, wherein the establishing the connection includes establishing management and data path connectivity between the source storage and the storage accessed by the destination host platform.

17. The non-transitory, computer-readable storage medium of claim 15, wherein the source host platform and destination host platform are located at different locations or sites.

18. The non-transitory, computer-readable storage medium of claim 15, wherein the snapshot of the volume includes all objects to recreate a destination cluster of container-based application.

19. The non-transitory, computer-readable storage medium of claim 15, wherein the snapshot of the volume includes all objects to recreate a destination cluster of container-based application.

20. The non-transitory, computer-readable storage medium of claim 15, further comprising performing backup of the container-based application while allowing for instant access.
